(19) United States
(12) Patent Application Publication
(10) Pub. No.: US 2026/0370584 A1
(43) Pub. Date: Nov. 19, 2026

(54) DETERMINING LATENCY IN A SYSTEM

(71) Applicant: Telefonaktiebolaget LM Ericsson (publ), Stockholm (SE)

(72) Inventors: Erik WESTERBERG, ENSKEDE (SE); Sofia SVEDEVALL, BROKIND (SE); Christian SKÄRBY, STOCKHOLM (SE); Anders K ERIKSSON, UPPSALA (SE); Johnny KARLSEN, JÄRFÄLLA (SE)

(73) Assignee: Telefonaktiebolaget LM Ericsson (publ), Stockholm (SE)

(21) Appl. No.: 19/133,829

(22) PCT Filed: Dec. 2, 2022
(86) PCT No.: PCT/EP2022/084280

§ 371 Date: May 29, 2025

(51) Int. Cl. H04L 43/0852; H04L 43/0817

(52) U.S. Cl. CPC H04L 43/0858; H04L 43/0817

(57) ABSTRACT

Methods and apparatus are provided. In some examples, a method of determining a latency in a system comprising one or more network nodes is provided. The method comprises determining an amount of first data received at the system in a first time period, and determining a second time period or a time instant by which all of the first data has been sent or consumed by the system. The method also comprises determining the latency in the system based on a difference between the first time period and the second time period or time instant by which all of the first data has been sent or consumed by the system.

### TECHNICAL FIELD

Example embodiments of this disclosure relate to determining latency, such as for example a latency upper bound, in a system that may comprise one or more network nodes.

### BACKGROUND

A precise and cost-efficient method to measure an upper bound for latency of data transmitted between two reference points is useful for a large set of use cases. While applicable to any information and communication technology (ICT) system, the value of accurately measuring the upper latency bound (also referred to herein as bounded latency) is particularly valuable in a mobile system, such as those specified in 3GPP. This is because the latency in such systems can vary significantly with varying radio conditions and load, and as a result the latency is difficult to predict and control.

By measuring the latency bound in a node or system, it may be possible to understand the quality of experience for end users that are using latency-sensitive applications. These may include for example cloud gaming, real-time video, remote driving of vehicles, augmented reality, virtual reality and more. It may also possible for mobile operators to measure when and where unacceptable latency spikes (e.g. packet latency above a threshold) appear in the network, and under what circumstances it is possible to guarantee good performance for latency-sensitive applications.

In addition, it may be possible with a reliable and accurate method for measuring latency for mobile operators to measure where network capacity expansions are needed, and to measure after the capacity expansion that the objectives for capacity expansions are met.

In some cases, with reliable and accurate measurements of latency, network operators may be able to offer connectivity services with performance guarantees and service-level agreements (SLAs) for connectivity relevant to latency-sensitive applications. This is both a necessary enabler for services that must not fail (such as remote driving) as well as a feature that increases the value of a service compared to a service where no SLAs can be given.

Finally, a reliable and accurate measurement method for the upper latency bound may be useful for automating a mobile network by means of intents. Intent based automation is a promising technology for controlling a system not by means of configuration parameters, but by means of intents that the system shall strive to satisfy. Intent-based automation has successfully been demonstrated in data centers and transport systems, and research is ongoing to understand how to apply intent-based automation to mobile networks. At the core of intent-based operation is the ability to measure the performance of a data flow in terms of bandwidth and bounded latency.

There are currently some methods for measuring the latency for packets through an ICT system. Each method has its merits and drawbacks, and no existing solution can measure the upper latency bound in a data stream with high accuracy at reasonable processing cost. One example comprises measuring the latency of each Protocol Data Unit (PDU) in the system. This method clocks the arrival time of each PDU across the incoming reference point A and clocks the exit time for same packet as it successfully transmitted over reference point B. While this gives an accurate measure of the latency—including average latency, minimum latency, latency jitter and an upper latency bound—it suffers from high cost for processing (every packet needs to be clocked) and scales very poorly with increased data volumes. If the number of PDUs in a stream increases with a factor ×10, for example, then the cost also increases by ×10. This is a major problem for high-bandwidth services such as extended reality and high-resolution real-time video. Moreover, this method is difficult in systems where the two reference points are not part of the same subsystem, and in particular when the two reference points belong to different administrative and/or legal domains. As an example, in a mobile system the first reference point may be in a mobile station, and the second measurement point may be in a network node deployed in a cloud center. In that case, it is not possible to use a single clock that starts/stops as the reference points are in different parts of the network.

In another example, a method similar to that described above is used but only for a subset of the PDUs to get a statistical measure of latency. This method does not suffer from the processing cost drawback of the method described above as the number of packets sampled does not need to grow as the traffic volume grows. However, the sampling has should to be done very frequently to accurately measure the occurrence of rare events, which are often the ones that break a specific latency bound. Therefore, while useful for latency averages and reasonable from a processing cost perspective, this method fails to measure a small percentage of PDUs violating a given latency bound. This method also shares the problem of the method described above in terms of distributed reference points, which is more significant for this method as the two different subsystems must be agree on packet identities and coordinate their random sampling so that it is the same packets that are sampled in both subsystems.

### SUMMARY

Examples of this disclosure may have certain advantages. For example, examples of this disclosure may enable latency or bounded latency in a network node to be determined at a moderate cost in terms of processing and memory. In particular, in some examples, the processing and memory required may not grow with the number of packets in a flow whose latency is being determined, which makes it possible to cost-efficiently monitor latency metrics for latency-sensitive and high-throughput services such as cloud gaming, augmented reality and virtual reality for example.

One aspect of the present disclosure provides a method of determining a latency in a system comprising one or more network nodes. The method comprises determining an amount of first data received at the system in a first time period, and determining a second time period or a time instant by which all of the first data has been sent or consumed by the system. The method also comprises determining the latency in the system based on a difference between the first time period and the second time period or time instant by which all of the first data has been sent or consumed by the system.

Another aspect of the present disclosure provides apparatus for determining a latency in a system comprising one or more network nodes. The apparatus comprises a processor and a memory. The memory contains instructions executable by the processor such that the apparatus is operable to determine an amount of first data received at the system in a first time period, determine a second time period or a time instant by which all of the first data has been sent or consumed by the system, and determine the latency in the system based on a difference between the first time period and the second time period or time instant by which all of the first data has been sent or consumed by the system.

An additional aspect of the present disclosure provides apparatus for determining a latency in a system comprising one or more network nodes. The apparatus is configured to determine an amount of first data received at the system in a first time period, determine a second time period or a time instant by which all of the first data has been sent or consumed by the system, and determine the latency in the system based on a difference between the first time period and the second time period or time instant by which all of the first data has been sent or consumed by the system.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a flow chart of an example of a method of determining a latency in a system;

FIG. 2 shows an example of a system in which a latency may be determined;

FIG. 3 shows an example of the network node of FIG. 2 including buffered data in a buffer;

FIG. 4 shows another example of a system in which a latency may be determined;

FIG. 5 shows an example of PDUs in a process for determining a latency; and

FIG. 6 is a schematic of an example of an apparatus for determining a determining a latency in a system comprising one or more network nodes.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g. analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g. digital or analogue) circuitry including but not limited to application specific integrated circuit(s) (ASIC) and/or field programmable gate array(s) (FPGA(s)), and (where appropriate) state machines capable of performing such functions.

Examples of this disclosure may provide solutions for one or more of the above-mentioned problems. In some examples, time is segmented into short time periods (for example, of the order of 5 ms), and then an upper bound for the latency of the set of PDUs that arrived to the system during that period is determined. As explained further below, this may be done for example by measuring once for each period the amount of data that arrived at the system during that period (e.g. was received at the system) and the amount of data exiting the system during same period. Alternatively, for example, the data volume arriving to the system during each period and the volume of data in the system buffer (e.g. at the end of each period) may be measured.

The data measured as suggested above may be used to derive an upper bound of the latency for data (or packets) arriving in each period. The first benefit compared to published technology is that the measurements may be done once every period regardless of the number of packets arriving or data volume. Thus the measurement is cost efficient and the cost is unaffected by the number of packets in the flow or the data volume. As such it is quite affordable to measure the latency bound also for high-bandwidth services such a real time video, cloud gaming and extended reality (XR).

Another benefit of examples of this disclosure is applicability to distributed systems. As long as the two subsystems agree on the measurement periods—which may employ for example a very modest level of time synchronization typically available from the global time known in each system—the traffic volumes can be measured independently and reported to an analytics system that determines the latency (or latency upper bound). The analytics system may be included in one of the distributed systems or may be separate.

The accuracy of the latency may for example be given by the length of the time period between measurements. The accuracy is typically the twice the time period for example, so if a latency bound of say 100 ms is to be measured then a suitable time-period between measurements can be e.g. 10 ms. The total inaccuracy is thus bounded by 2 times the time period. In this way, the accuracy of latency determined according to examples of this disclosure can be configured in an arbitrary manner at the cost of increased number of measurements in the system.

Thus, examples of this disclosure may provide the advantage that bounded latency in a system of one or more network nodes can be monitored and assured at a moderate cost in terms of processing and memory. In particular, the processing and memory required does not grow with the number of packets or data volume in a flow, which makes it possible to cost-efficiently monitor bounded latency metrics for high-throughput services such as cloud gaming, augmented reality and virtual reality.

This in turn makes it possible for service providers to accurately monitor the bounded latency for such services for each flow and each user, and to use this information about potential bounded latency breaches to accurately estimate the quality of experience for the service as well as derive service-level agreement (SLA) compliance whenever such is based on bounded latency metrics. This capability may for example form the baseline for a large set of applications including mobile network service assurance, intent-based automation, AI/ML-based radio network algorithms, network planning, network simulations and mobile network tuning and optimization.

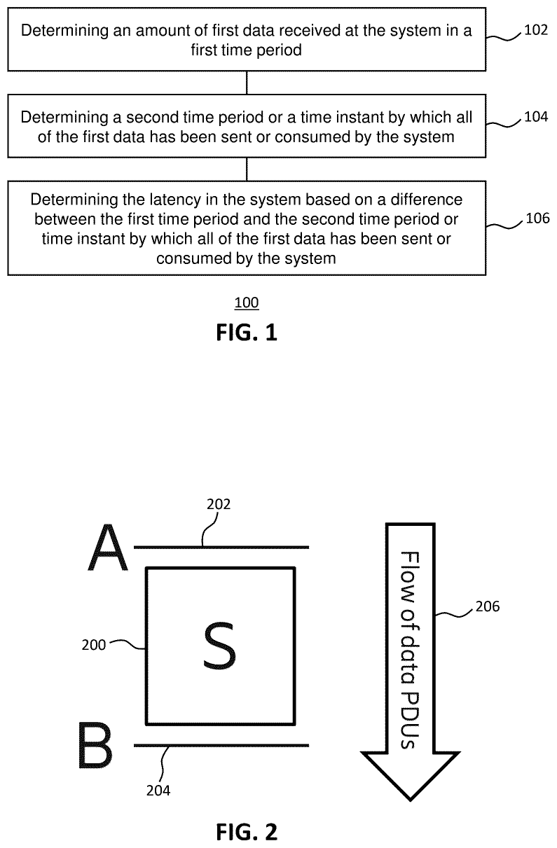

FIG. 1 is a flow chart of an example of a method 100 of determining a latency in a system comprising one or more network nodes. Each of the one or more network nodes may be for example a node in a mobile network, such as for example a User Equipment (UE), base station control unit (CU), base station distributed unit (DU), eNB, gNB, eNB-CU, eNB-DU, gNB-CU, gNB-DU, core network node, router or any other network node. Each network node may also be an O-RAN counterpart to these examples, e.g. O-DU, O-CU etc. Furthermore, in some examples, the latency is determined for a subset of activities in the system or each network node, such as for example the latency for or between one or more particular Open Systems Interconnection (OSI) layers, for particular flows or logical channels, etc.

In some examples, the latency comprises a latency upper bound in the system. The method 100 may in some examples be performed by a node in the system (which may be for example one of the one or more network nodes) or a different node in the system. Alternatively, the method 100 may be performed by a node that is not in the system, e.g. a network node in a different system or network.

FIG. 2 shows an example of a system 200 in which a latency may be determined in accordance with the method 100 of FIG. 1. The first data may be received at a first interface 202 of the system 200 (e.g. a first interface of a first network node of the system 200) and may be sent from a second interface 204 of the system 200 (e.g. a second interface of the first network node or a second network node of the system 200). The flow 206 of data PDUs (a non-limiting example of the first data) is shown from the first interface 202 to the second interface 204.

Examples of interfaces include the 3GPP interfaces Uu, F1, N3, S1, and N6. These are the user-plane interfaces where user data flows, and which may be the interfaces in embodiments of this disclosure. However, embodiments of this disclosure may also apply to control-plane interfaces, such as for example the control phase 3GPP interfaces N1, N2, N3 and the O-RAN interfaces A1, O1, and ‘Open Fronthaul interface’.

The method 100 comprises, in step 102, determining an amount of first data received at the system 200 in a first time period. The first data may for example be in the form of one or more packets, PDUs, SDUs or any other data units. Determining the amount of the first data received at the system 200 may comprise for example determining the amount of the first data received by a first network node in the system 200, or determining the amount of first data received by a first interface (e.g. the interface 202) of the first network node in the system 200.

Step 104 of the method 100 comprises determining a second time period or a time instant by which all of the first data has been sent or consumed by the system 200. This may comprise, for example, determining the second time period or the time instant by which all of the first data has been sent by a second network node in the system (which may be the same as or different to the first network node referred to above); determining the second time period or the time instant by which all of the first data has been sent by a first interface (e.g. the interface 204) of the system 200; or determining the second time period or the time instant by which all of the first data has been consumed by the system 200, such as for example the first network node in the system 200 or a different network node in the system 200. Here, consumed by the system 200 may be for example sent to or received at a terminating point in the system such as an application that uses the first data.

Step 106 of the method 100 comprises determining the latency in the system based on a difference between the first time period and the second time period or time instant by which all of the first data has been sent or consumed by the system 200.

In some examples, determining the amount of the first data received at the system may comprise receiving an indication identifying the amount of data received at the system during the first time period, and/or receiving an indication identifying receiving an indication identifying an amount of respective data sent or consumed by the system in the first time period and an amount of buffered data in the system in the first time period. This may be for cases where for example the node performing the method 100 is not part of the system 200 for which latency is being determined, although the node performing the method 100 may be for example part of a system in which the system 200 is a subsystem, the same network, or a different system or network.

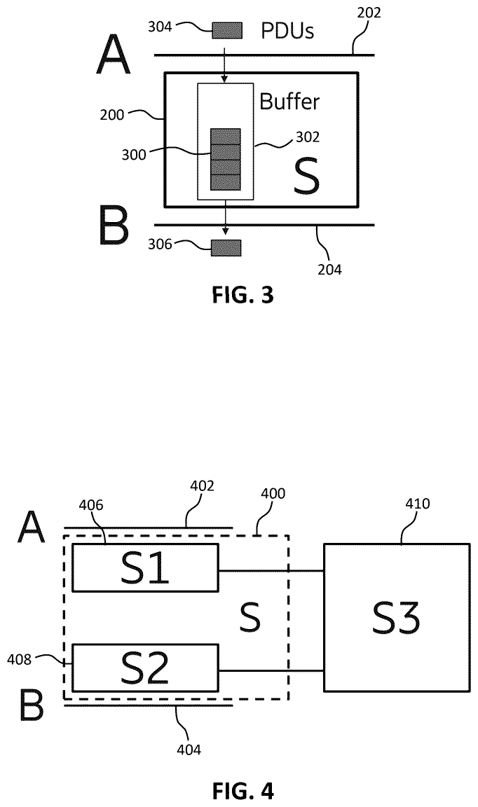

Regarding buffered data, in some examples the latency may be determined also based on the amount of buffered data in the system in the first time period (e.g. at the start or the end of the first time period). Thus, for example, if at the first time period (e.g. beginning or end), the buffer contains buffered data and the system 200 has received the first data, then the latency may be determined based on the total of the amount of the first data and the amount of buffered data. That is, for example, once the total amount of data has been sent or consumed by the system 200 after the first time instant, then the data sent or consumed by the system 200 is assumed to include the first data and the buffered data at the end of the first time period. By determining the second time instant in which the amount of data sent since the first time instant (or period) equals or exceeds the total, the latency can be determined. FIG. 3 shows an example of the system 200 of FIG. 2 including buffered data 300 in a buffer 302. The buffer 300 may be for example a single buffer, several buffers, or simply a representation of data contained within the system 200 after it has been received at the first interface 202 and before it is sent from the second interface 204 or consumed by the system 200.

FIG. 4 shows another example of a system 400 in which a latency may be determined.

The first data may be received at a first interface 402 of the system 400 (e.g. a first interface of a first network node of the system 400) and may be sent from a second interface 404 of the system 400 (e.g. a second interface of the first network node or a second network node of the system 400). In the example shown in FIG. 4, the system 400 comprises two subsystems 406 and 408, where subsystem 406 is associated with the first interface (or reference point) 402 and the second subsystem 408 is associated with the second interface (or reference point) 404. In other examples, however, there may be any number of one or more subsystems in the system 400. Each subsystem may comprise one or more network nodes or networks in some examples.

In the system 400 shown in FIG. 4, measurements may be performed by each subsystem (e.g. of amount of data arriving at the subsystem in each time period, the amount of data sent by the subsystem in each time period and/or the amount of buffered data in the subsystem at the start or end of each time period), such as in the first subsystem 406 with respect to the first interface 402 and in the second subsystem 408 with respect to the second interface 404. In the examine system 400 shown in FIG. 4, these measurements may be communicated to a node 410 that is not part of the system 400 and which determines the latency of the system 400 between the interfaces 402 and 404. There may also be a separate node determining the latency in some examples of the system 200 shown in FIGS. 2 and 3. Alternatively, in some examples, the node 410 determining the latency may be included in the system 400, in which case the measurements may also be communicated to this node within the system 400.

In some examples, there may be synchronization between the two subsystems 406 and 408 in terms of the definition of a Packet Data Unit (PDU). In some examples, there may also be time synchronization of the measurements in the subsystems 406 and 408. The precision of the time synchronization may impact the precision of the latency measurement, and may for example be done explicitly with time synchronization technology, or alternatively by each subsystem referring to a global time (e.g. such as kept individually by each subsystem).

In some examples, therefore, such as examples where measurements are communicated to the node 410 for example, determining the second time period or the time instant by which all of the first data has been sent or consumed by the system may comprise periodically receiving (e.g. from the system 400 or one or more of its subsystems) an indication identifying an amount of respective data sent or consumed by the system in each of a plurality of time periods including the first time period; periodically receiving (e.g. from the system 400 or one or more of its subsystems) an indication identifying an amount of buffered data in the system in each of the plurality of time periods; and/or periodically receiving (e.g. from the system 400 or one or more of its subsystems) an indication identifying an amount of respective data received by the system in each of a plurality of time periods. As indicated above, the amount of buffered data in the system in each of the plurality of time periods may be for example the amount of buffered data in the system at the start of the time period or the end of the time period. The time periods may be consecutive and/or of equal duration in some examples.

Determining the second time period may also in some examples comprise determining the second time period by which a total amount of data sent or consumed by the system between and including the first time period and the second time period is equal to or greater than the amount of the first data. Additionally or alternatively, determining the second time period may also in some examples comprise determining the second time period by which a total amount of data sent or consumed by the system between and including the first time period and the second time period is equal to or greater than the amount of the first data plus an amount of buffered data in the system in the first time period.

The method 100 may also comprise determining the total amount of data sent or consumed by the system (e.g. system 200 or 400) between and including the first time period and the second time period based on the amounts of respective data received by the system in each of the plurality of time periods and the amounts of respective data sent or consumed by the system in each of the plurality of time periods; and/or the amounts of respective data received by the system in each of the plurality of time periods and the amounts of buffered data in the system in each of the plurality of time periods.

In some examples, where there is buffered data, determining the second time period in step 104 may comprise determining the second time period by which the amount of buffered data in the system at the start of the first time period and the amount of the first data has been sent or consumed by the system since the start of the first time period. That is, for example, second time period of the plurality of time periods by which the total of the amount of buffered data at the start of the first time period plus the amount of first data received at the system in the first time period has been sent or consumed by the system.

Determining the latency in the system in step 106 of the method 100 may for example comprise determining the latency based on a difference between the first time period and the second time period or on a number of time periods between the first time period and the second time period. Determining the latency based on the difference between the first time period and the second time period may for example comprise determining a time difference between a start of the first time period and an end of the second time period; determining a time difference between a start of the first time period and a start of the second time period; determining a time difference between an end of the first time period and an end of the second time period; or determining a time difference between an end of the first time period and a start of the second time period.

In some examples, the first data received at the system in step 102 is to be sent to a different system, sent to a network node not in the system, or consumed by an application in the system. Additionally or alternatively, in some examples, the first data may be received from a different system, received from a network node not in the system, or generated by an application in the system.

As a specific example, as referred to above, FIG. 3 shows an example of the network node 200 of FIG. 2 including buffered data 300 in a buffer 302 (although there may also be buffered data in the system 400 shown in FIG. 4). These systems may represent in a general way various subsystem(s) in a system in which latency may be determined, such as for example a packet data communication system. In one example, the system 200 may be a 4G base station in which case the interfaces (or reference points) 202 and 204 may be the 3GPP interfaces S1 and Uu respectively. This may also be the case in an Open Radio Access Network (O-RAN) example. In another example, from a routed fiber network the system 200 may be a router, in which case the interfaces (or reference points) 202 and 204 may be the router's network interface connectors (NICs) for incoming and outgoing data flows respectively. Without loss of generality, and to provide a general description of examples of this disclosure, the system 200 is represented as a single system including a buffer 302 that holds the first data (e.g. PDUs) from its arrival over interface (or reference point) 202 to its transmission or consumption over interface (or reference point) 204.

Considering uplink traffic and a 5G network, the system 200 or 400 can be for example the lower layers of the 5G mobile station (or UE) plus the 5G network. In this case, for example, the interface 202 or 402 may be the mobile station internal interface between the application and the radio layer, and the interface 204 or 404 may be the N6 interface. In yet another example from a routed fiber network, the system 200 or 400 may be a single router where the interfaces are the router's network interface connectors (NICs) for incoming and outgoing data flows respectively. In still another example, the system 200 or 400 may be the sum of a 3GPP digital unit (DU) and radio unit (RU). In O-RAN terminology, this is the sum of the O-DU and O-RU. The interface 202 or 402 may then be the 3GPP F1 interface, and the interface 204 or 404 may then be the 3GPP Uu interface. In an O-RAN implementation, the interfaces may be the 3GPP interfaces F1 and Uu which are inherited in the O-RAN architecture.

In operation, examples of this disclosure may operate as follows. Starting with an empty buffer—for example, at system start up, or before data in a session starts to flow—the system 200 or 400 may be configured with the measurement periodicity, ie. the time interval between two consecutive measurements of the buffer status. This time interval may determine the length of the first and second time periods (and other time periods) referred to above in some examples. In this example, the time interval is set to 5 ms. In some examples, the system may be given an instruction to start the measurement activity, such as for example from an application or system within the system or from another node.

The system 200 or 400 then measures and records the volume of data in the buffer—measured e.g. in bytes—every 5 ms in this example, though in other examples the time periods may be of any length. For each 5 ms time period, the system 200 or 400 shall also measure and record the amount of data—measured e.g. in bytes—that was received at the system over the interface 202 or 402. As time progresses, PDUs 304 may arrive at the system 200, and are stored in the buffer 302 until they are successfully sent from the interface 204 or 404. Here, in some examples, the buffer 302 may represent one or more actual buffers or instead may more generally represent data that is stored in and/or is traversing through the system 200 or 400.

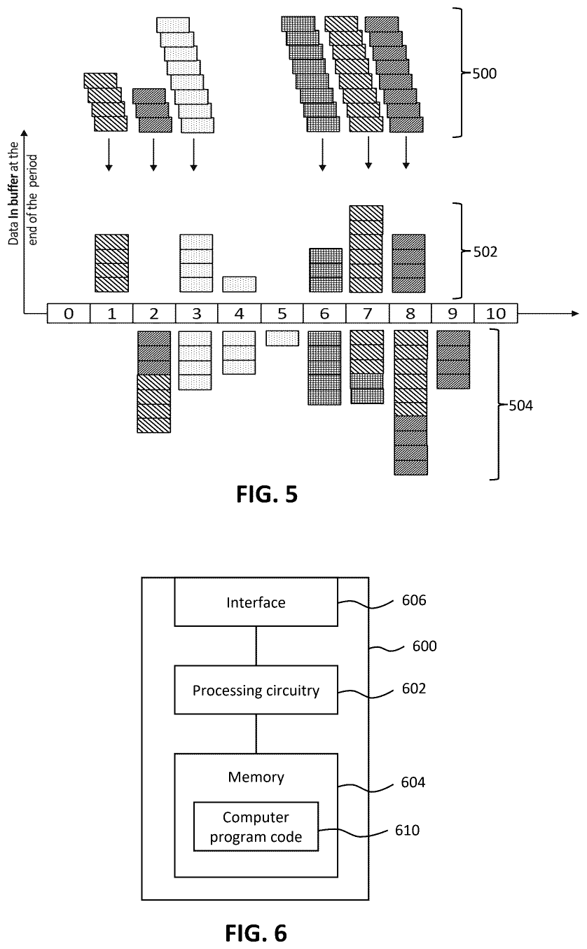

An example of PDUs in this process for determining a latency is illustrated in FIG. 5. In FIG. 5, the horizontal axis represents time periods, which are numbered from 0 to 10, such as for example 5 ms time periods. Each shaded box in FIG. 5 represents a PDU of size 25 bytes, though in other examples they may represent any data units of any size (including in some examples PDUs of different sizes). The upper PDUs 500 represent the data volume that enters the buffer 302 during each time period 0-10. The middle set of PDUs 502 represent the PDUs in the buffer 302 at the end of the time period. The lower set of PDUs 504 represent the PDUs that have been sent or consumed by the system during the time period. Thus, for example, in time period 1, four PDUs are received and these are stored in the buffer, and no PDUs are sent or consumed. In time period 2, for example, three PDUs are received and seven are sent or consumed, which corresponds to the number of PDUs received in time periods 1 and 2, and thus the buffer is empty by the end of time period 2.

For each time period, the amount of data received in the time period (e.g. first data in a first time period), represented by PDUs 500, is determined. Also, either the amount of data (e.g. PDUs 502) in the buffer, or the amount of data (e.g. PDUs 504) sent or consumed, in the time period is determined. The amount of data sent or consumed in a time period may be determined from the amount of data received and the amount of data in the buffer (plus the amount of data in the buffer from the previous time period, if any). Similarly, the amount of data in the buffer may be determined from the amount of data received in a time period and the amount of data sent or consumed in the time period (plus the amount of data in the buffer from the previous time period, if any). For example, the following formula may provide the buffer volume at the end of a time period numbered N:

Buffer volume at end of period N=Buffer volume at end of period N−1+Data volume arriving during period N−Data sent or consumed in period N).

The following table indicates how much data arrives in each time period and is in the buffer at the end of in each time period in the example shown in FIG. 5:

| Time period | Arriving | In buffer |
|---|---|---|
| 0 | 0 | 0 |
| 1 | 100 bytes | 100 bytes |
| 2 | 75 bytes | 0 |
| 3 | 200 bytes | 100 bytes |
| 4 | 0 | 25 bytes |
| 5 | 0 | 0 |
| 6 | 200 bytes | 75 bytes |
| 7 | 200 bytes | 150 bytes |
| 8 | 200 bytes | 100 bytes |
| 9 | 0 | 0 |
| 10 | 0 | 0 |

Considering time period 7 in FIG. 5 and the above table, the arriving PDUs 500 comprise 8×25 bytes=200 bytes arriving in this time period. There is also a total volume of 6×25 bytes in the buffer at the end of time period 7. As there were 3×25 bytes=75 bytes in the buffer at the end of time period 6 (as indicated in the table), it can be concluded that 5×25 bytes=125 bytes were sent or consumed in time period 7.

In other examples, the data sent or consumed may be determined (e.g. measured) instead, according to the following table which is also based on the example of FIG. 5:

| Time period | Arriving | Sent/Consumed |
|---|---|---|
| 0 | 0 | 0 |
| 1 | 100 bytes | 0 |
| 2 | 75 bytes | 175 bytes |
| 3 | 200 bytes | 100 bytes |
| 4 | 0 | 75 bytes |
| 5 | 0 | 25 bytes |
| 6 | 200 bytes | 125 bytes |
| 7 | 200 bytes | 125 bytes |
| 8 | 200 bytes | 250 bytes |
| 9 | 0 | 100 bytes |
| 10 | 0 | 0 |

The sent/consumed data can be derived from the buffered data, and vice versa, as indicated above.

Based on the set of measurements of the influx of data per time period and the volume of data in the system (buffer) at the end of each time period, or the amount of data sent or consumed in the time period, in some examples, the upper bound for the latency in the system 200 or 400 of the data arriving in each time period may be determined, as follows. The volume of data in the buffer at the start of a time period N is determined, which is given by the volume of data in the buffer at the end of interval N−1. In time period 7 in FIG. 5, this would be 75 bytes (the volume in the buffer at the end of measurement period 6). The volume of data arriving in time period N (also referred to as first data in the methods described above) is added to this. In time period 7, this would be 200 bytes. Under the assumption of in-order delivery of data units, the 75 bytes of data in the front of the buffer from time period 6 will be delivered first, and then the 200 bytes of data that arrived in the interval N, in one or more time periods including the time period N. As long as the system has not sent or consumed a total of 275 bytes of data—measured from the start of time period N—there are still PDUs in the set of PDUs that arrived in period N that have yet not been sent or consumed. Furthermore, when the system has sent or consumed 275 bytes of data or more measured from the start of time period N, then all PDUs that arrived in period N have been sent or consumed. By monitoring the volumes of data arriving and volumes remaining in the buffer in subsequent time periods following time period N, it can be determined in which time period the accumulated volume of data sent or consumed from the start of time period N equals or is greater than the sum of the data volume at the start of period N and the volume of data arriving during period N (e.g. 275 bytes in the case of time period 7). If this occurs in time period N+m, it can be determined that the data that arrived in period N has all been sent or consumed by time period N+m. Therefore, the longest time any of the data arriving in time period N can have spent in the system 200 or 400 is if it entered at the start of time period N and was transmitted at the end of period N+m. This longest time cannot be larger than (m+1) time periods. Thus, the latency upper bound for the first data received in time period N is (m+1) time periods.

Similarly, at least some of the data must have been transmitted no sooner than in period N+m and the shortest time that packet could have spent in the system 200 or 400 is if it arrived at the end of period N and was transmitted at the start of period N+m. This gives a lower bound of m−1 time periods for any of the data arriving in period N. Thus, all data arriving in period N was sent or consumed by the system by a second time instant with a time T given by (m−1)<T<(m+1), and m+1 is an upper bound to the latency of any data arriving in period N. In the example in FIG. 5, once again considering time period 7, it can be seen that that a total of 125B was sent or consumed in time period 7, which is less than 275 bytes (75 bytes in buffer at start of period plus 200 bytes arriving in period 7), so that not all of the data arriving in time period 7 has been sent or consumed. Determining that 250 bytes were sent or consumed in period 8, it can be determined that by the end of period 8 an accumulated volume of 375 bytes has been sent or consumed since the start of period 7. As 375 bytes is more than 275 bytes, all PDUs arriving in period 7 have been sent or consumed by the system 200 or 400 at the end of time period 8. Thus, no data arriving in time period 7 has spent more than a maximum of two time periods (=2×5 ms in this example) before being sent, and the latency is therefore bounded by 10 ms in this example.

Examples of this disclosure may also apply in scenarios where there may be out-of-order delivery. Out-of-order delivery, or retransmissions in the case of 3GPP and O-RAN systems, may add an additional uncertainty to the determined latency. This additional uncertainty may in some examples be bounded in size by the maximum out-of-order delivery (or re-transmission) time. In a particular example, in a 3GPP system, HARQ retransmissions (retransmissions over the radio interface) typically occur with a period of 2-8 ms. The maximum retransmission time is thus the re-transmission period multiplied by the maximum number of re-transmissions. In another example, in a 3GPP 5G system supporting Cloud Gaming services, the retransmission period can be set to 4 ms and the maximum number of re-transmissions can be set to 4. This would mean that a determined latency may have an extra uncertainty of up to 4 ms×4 retransmissions=16 ms. If a better precision is wanted, the maximum number of retransmissions could be set to 2 for example, resulting in an extra uncertainty of up to 4×2=8 ms. In many example applications, the uncertainty from the out-of-order delivery and/or retransmissions may be known or can be accurately measured using existing technology. Also, in many example applications this uncertainty can be smaller than the desired accuracy of the determined latency, and hence embodiments of this disclosure may be used and can provide value even for out-of-order delivery systems.

Examples of this disclosure may be used for determining latency in a single-node system, where the system 200 or 400 comprises a single node, or in a multi-node system. In an example, in a mobile system, the system may include nodes a and b which can be for example the 3GPP nodes CU-CP and DU respectively, or the 3GPP nodes UPF and DU respectively. In an O-RAN mobile system, the nodes a and b may be for example O-CU-CP and O-DU respectively, or the nodes UPF and O-DU respectively. In a routed IP system, for example, the nodes can be any two routers in the network. In a system with application nodes such as application server node and application client node, the two nodes a and b can be the application server node and the application client nodes, wherein the latency in this case is determined between the application server and the application client.

In a multi-node system, determining latency using amounts of received data and sent/consumed data may be preferred over using amounts of received data and buffered data, as measuring data flux over two interfaces may in some examples be less complex and costly than to record the amount of data in the system between the interfaces, may correspond for example to a (real or virtual) buffer such as the buffer 302 shown in FIG. 3.

In a multi-node system, the following preparation steps may in some examples be done before the measurement starts:
1. The two nodes a and b agree on the definition of the PDUs, and which data volumes that shall be recorded.
2. The two nodes a and b agree on a common reference for time (“time synchronization”).

In some examples, the nodes a and b may be two nodes of a multi-node system that includes one or more further nodes. However, the nodes a and b may be where the data enters (e.g. is received at or generated by) and leaves (e.g. is sent from or consumed by) the system respectively, and thus correspond to the interfaces 202/402 and 204/404 respectively.

In some examples, such as for example the system 400 shown in FIG. 4, the two subsystems 406 and 408 may measure data volumes (e.g. bytes) in same way. In some systems, data (e.g. bytes, overhead etc.) may be removed or added by processes between the interfaces 402 and 404, and such removals and additions should be accounted for in some examples. One example of PDU modifications is adding and removing PDU headers to PDUs as they are moved between different protocol layers, such as for example when the Radio Link Control (RLC) layer in a 3GPP system adds and removes bytes to PDUs in the form of the RLC header. Examples of ensuring that the two subsystems 406 and 408 measure data volumes in the same way include the following:
a. The two subsystems 402 and 404 are configured to measure on the same protocol layer, and it is known that no modifications of the PDUs on this protocol layer is done by or between the two subsystems. One example of this is a 3GPP system where the first subsystem 402 is a User Equipment, the second subsystem 408 is a gNB and the protocol layer is PDCP.
b. The two subsystems 406 and 408 are configured to measure PDUs where a known and non-dynamic (fixed overtime) modification of the PDUs results in a known difference in bytes measured by the two subsystems 406 and 408 over the interfaces 402 and 404 respectively. In this case, any of the subsystems 406 and 408 or the node 410 can be configured to compensate for the known difference by adding or subtracting the data volumes that were removed or added between the interfaces 402 and 404.
c. There is one or mode systems between the interfaces A and B that dynamically modifies the number of bytes of the PDUs in the data flow. In this case, the system adding or removing data volume from the flow shall communicate these additions and subtractions of data to either of the subsystems 406 and 408 or the node 410 in order for that subsystem or node to compensate for the changing data volume by adding or subtracting from the measured amount of data volumes the amount of data that was removed or added between the interfaces 402 and 404.

In some examples, the two subsystems 402 and 404 of the system 400 (or the network nodes associated with the interfaces 202/402 and 204/404) may use the same time periods for measuring the data volumes received and sent over the interfaces 202/402 and 204/404. While using the same time period is not a strict requirement, as measured data volumes can be adjusted to work also for different times periods of measurements between subsystems or network nodes, using the same time periods (e.g. same length and/or aligned in time) may in some examples reduce the complexity of measurements and/or the calculation for determining the latency, and may also in some examples increase the precision of the measure of the upper latency bound if the same time period is used.

The length of the time period can be configured either by configuring each node or subsystem to set this time period to be the same, or by communication between the two nodes or subsystems. The starting time between the two time periods may in some examples be simultaneous (or substantially simultaneous) relative a common global time. A difference in starting time may in some examples result in an offset of the determined bounded latency. As an example, if node a is a 3GPP UE and the node b is a 3GPP CU-UP, and there is a 2 ms difference in the starting time of the measurement period between the CU-UP and UE, then the latency bound will be off by the same amount, in this case 2 ms. Thus, in some examples, the time synchronization between the two nodes or subsystems a and b may only be precise enough to meet the requirements of the precision of the determined latency. In the example above, a 2 ms measurement inaccuracy may be acceptable for example in a cloud gaming data flow, where the latency bound shall be under 50 ms, and where a 2 ms error in the bounded latency measure is tolerable. Depending on the error tolerance in the determined latency, the two nodes or subsystems a and b may for example achieve the corresponding precision in their relative synchronization of time using known methods, e.g. time synchronization using GPS, time synchronization using a common time-stepped radio interface, or transport network synchronization technologies.

FIG. 6 is a schematic of an example of an apparatus 600 for determining a latency in a system (e.g. the system 200 or 400) comprising one or more network nodes. The apparatus 600 comprises processing circuitry 602 (e.g. one or more processors) and a memory 604 in communication with the processing circuitry 602. The memory 604 contains instructions, such as computer program code 610, executable by the processing circuitry 602. The apparatus 600 also comprises an interface 606 in communication with the processing circuitry 602. Although the interface 606, processing circuitry 602 and memory 604 are shown connected in series, these may alternatively be interconnected in any other way, for example via a bus.

In one embodiment, the memory 604 contains instructions executable by the processing circuitry 602 such that the apparatus 600 is operable/configured to determine an amount of first data received at the system in a first time period, determine a second time period or a time instant by which all of the first data has been sent or consumed by the system, and determine the latency in the system based on a difference between the first time period and the second time period or time instant by which all of the first data has been sent or consumed by the system. In some examples, the apparatus 600 is operable/configured to carry out the method 100 described above with reference to FIG. 1.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method of determining a latency in a system comprising one or more network nodes, the method comprising:
determining an amount of first data received at the system in a first time period;
determining a second time period or a time instant by which all of the first data has been sent or consumed by the system; and
determining the latency in the system based on a difference between the first time period and the second time period or time instant by which all of the first data has been sent or consumed by the system.

2. The method of claim 1, wherein determining the amount of the first data received at the system comprises:
determining the amount of the first data received by a first network node in the system; or
determining the amount of first data received by a first interface of the first network node in the system.

3. The method of claim 1, wherein determining the second time period or the time instant by which all of the first data has been sent or consumed by the system comprises:
determining the second time period or the time instant by which all of the first data has been sent by a second network node in the system;
determining the second time period or the time instant by which all of the first data has been sent by a first interface of the first network node in the system; or
determining the second time period or the time instant by which all of the first data has been consumed by the first network node in the system.

4. The method of claim 1, wherein determining the amount of the first data received at the system comprises:
receiving an indication identifying the amount of data received at the system during the first time period; and/or
receiving an indication identifying an amount of respective data sent or consumed by the system in the first time period and an amount of buffered data in the system in the first time period.

5. The method of claim 1, wherein determining the second time period or the time instant by which all of the first data has been sent or consumed by the system comprises:
periodically receiving an indication identifying an amount of respective data sent or consumed by the system in each of a plurality of time periods including the first time period;
periodically receiving an indication identifying an amount of buffered data in the system in each of the plurality of time periods; and/or
periodically receiving an indication identifying an amount of respective data received by the system in each of a plurality of time periods.

6. The method of claim 5, wherein amount of buffered data in the system in each of the plurality of time periods comprises the amount of buffered data in the system at the start of the time period or the end of the time period.

7. The method of claim 5, wherein determining the second time period comprises:
determining the second time period by which a total amount of data sent or consumed by the system between and including the first time period and the second time period is equal to or greater than the amount of the first data; or
determining the second time period by which a total amount of data sent or consumed by the system between and including the first time period and the second time period is equal to or greater than the amount of the first data plus an amount of buffered data in the system in the first time period.

8. The method of claim 7, comprising determining the total amount of data sent or consumed by the system between and including the first time period and the second time period based on:
the amounts of respective data received by the system in each of the plurality of time periods and the amounts of respective data sent or consumed by the system in each of the plurality of time periods; and/or
the amounts of respective data received by the system in each of the plurality of time periods and the amounts of buffered data in the system in each of the plurality of time periods.

9. The method of claim 5, wherein the plurality of time periods are consecutive and/or of equal duration.

10. The method of claim 4, wherein determining the second time period comprises determining the second time period by which the amount of buffered data in the system at the start of the first time period and the amount of the first data has been sent or consumed by the system since the start of the first time period.

11. The method of claim 1, wherein determining the latency in the first network node comprises determining the latency based on a difference between the first time period and the second time period or on a number of time periods between the first time period and the second time period.

12. The method of claim 11, wherein determining the latency based on the difference between the first time period and the second time period comprises:
determining a time difference between a start of the first time period and an end of the second time period;
determining a time difference between a start of the first time period and a start of the second time period;
determining a time difference between an end of the first time period and an end of the second time period; or
determining a time difference between an end of the first time period and a start of the second time period.

13. The method of claim 1, wherein the first data is to be sent to a different system, sent to a network node not in the system, or consumed by an application in the system.

14. The method of claim 1, wherein the first data is received from a different system, received from a network node not in the system, or generated by an application in the system.

15. The method of claim 1, wherein the latency comprises a latency upper bound in the system.

16. The method of claim 1, wherein the method is performed by a network node in the system or a node not in the system.

17. Apparatus for determining a latency in a system comprising one or more network nodes, the apparatus comprising a processor and a memory, the memory containing instructions executable by the processor such that the apparatus is operable to:
determine an amount of first data received at the system in a first time period;
determine a second time period or a time instant by which all of the first data has been sent or consumed by the system; and
determine the latency in the system based on a difference between the first time period and the second time period or time instant by which all of the first data has been sent or consumed by the system.

18. The apparatus of claim 17, wherein the memory contains instructions executable by the processor such that the apparatus is operable to determine the amount of the first data received at the system by:
determining the amount of the first data received by a first network node in the system; or
determining the amount of first data received by a first interface of the first network node in the system.

19. The apparatus of claim 17, wherein the memory contains instructions executable by the processor such that the apparatus is operable to determine the second time period or the time instant by which all of the first data has been sent or consumed by the system by:
determining the second time period or the time instant by which all of the first data has been sent by a second network node in the system;
determining the second time period or the time instant by which all of the first data has been sent by a first interface of the first network node in the system; or
determining the second time period or the time instant by which all of the first data has been consumed by the first network node in the system.

20. The apparatus of claim 17, wherein the memory contains instructions executable by the processor such that the apparatus is operable to determine the amount of the first data received at the system by:
receiving an indication identifying the amount of data received at the system during the first time period; and/or
receiving an indication identifying an amount of respective data sent or consumed by the system in the first time period and an amount of buffered data in the system in the first time period.

21. The apparatus of claim 17, wherein the memory contains instructions executable by the processor such that the apparatus is operable to determine the second time period or the time instant by which all of the first data has been sent or consumed by the system by:
periodically receiving an indication identifying an amount of respective data sent or consumed by the system in each of a plurality of time periods including the first time period;
periodically receiving an indication identifying an amount of buffered data in the system in each of the plurality of time periods; and/or
periodically receiving an indication identifying an amount of respective data received by the system in each of a plurality of time periods.

22. The apparatus of claim 21, wherein amount of buffered data in the system in each of the plurality of time periods comprises the amount of buffered data in the system at the start of the time period or the end of the time period.

23. The apparatus of claim 21, wherein the memory contains instructions executable by the processor such that the apparatus is operable to determine the second time period by:
determining the second time period by which a total amount of data sent or consumed by the system between and including the first time period and the second time period is equal to or greater than the amount of the first data; or
determining the second time period by which a total amount of data sent or consumed by the system between and including the first time period and the second time period is equal to or greater than the amount of the first data plus an amount of buffered data in the system in the first time period.

24. The apparatus of claim 23, wherein the memory contains instructions executable by the processor such that the apparatus is operable to determine the total amount of data sent or consumed by the system between and including the first time period and the second time period based on:
the amounts of respective data received by the system in each of the plurality of time periods and the amounts of respective data sent or consumed by the system in each of the plurality of time periods; and/or
the amounts of respective data received by the system in each of the plurality of time periods and the amounts of buffered data in the system in each of the plurality of time periods.

25. The apparatus of claim 21, wherein the plurality of time periods are consecutive and/or of equal duration.

26. The apparatus of claim 20, wherein the memory contains instructions executable by the processor such that the apparatus is operable to determine the second time period by determining the second time period by which the amount of buffered data in the system at the start of the first time period and the amount of the first data has been sent or consumed by the system since the start of the first time period.

27. The apparatus of claim 17, wherein the memory contains instructions executable by the processor such that the apparatus is operable to determine the latency in the first network node by determining the latency based on a difference between the first time period and the second time period or on a number of time periods between the first time period and the second time period.

28. The apparatus of claim 27, wherein the memory contains instructions executable by the processor such that the apparatus is operable to determine the latency based on the difference between the first time period and the second time period by:
determining a time difference between a start of the first time period and an end of the second time period;
determining a time difference between a start of the first time period and a start of the second time period;
determining a time difference between an end of the first time period and an end of the second time period; or
determining a time difference between an end of the first time period and a start of the second time period.

29. The apparatus of claim 17, wherein the first data is to be sent to a different system, sent to a network node not in the system, or consumed by an application in the system.

30. The apparatus of claim 17, wherein the first data is received from a different system, received from a network node not in the system, or generated by an application in the system.

31. The apparatus of claim 17, wherein the latency comprises a latency upper bound in the system.

32. The apparatus of claim 17, wherein the apparatus comprises or is comprised in a network node in the system or a node not in the system.

33. (canceled)

34. (canceled)
